(19) United States
(12) Patent Application Publication
(10) Pub. No.: US 2015/0207764 A1
(43) Pub. Date: Jul. 23, 2015

(54) METHOD AND DEVICE FOR SHARING DATA

(71) Applicant: Alibaba Group Holding Limited, George Town (KY)

(72) Inventors: Honghui He, Beijing (CN); Yukun Chen, Beijing (CN); Xin Ji, Beijing (CN); Pengjie Zhao, Beijing (CN); Bin Liu, Beijing (CN); Chunxia Li, Beijing (CN); Yali Wang, Beijing (CN); Wenlong Xie, Beijing (CN)

(21) Appl. No.: 14/600,728

(22) Filed: Jan. 20, 2015

(30) Foreign Application Priority Data
Jan. 22, 2014 (CN) 201410031049.3

(51) Int. Cl. H04L 12/58; G06F 3/0488; H04L 29/06

(52) U.S. Cl. CPC H04L 51/04; H04L 65/403; G06F 3/04883

(57) ABSTRACT

Embodiments of the present application relate to a method sharing data, a device for sharing data, and a computer program product for sharing data. A method for sharing data is provided. The method includes detecting a shaking operation performed on a device by a user, in response to the detecting of the shaking operation, performing screenshot processing of current data of an application to obtain screenshot data, and sending a sharing request regarding the screenshot data to a server to share the screenshot data.

### CROSS REFERENCE TO OTHER APPLICATIONS

This application claims priority to People's Republic of China Patent Application No. 201410031049.3 entitled A METHOD AND A DEVICE FOR SHARING DATA, filed Jan. 22, 2014 which is incorporated herein by reference for all purposes.

### FIELD OF THE INVENTION

The present application relates to a method and device for sharing data.

### BACKGROUND OF THE INVENTION

As the mobile Internet develops and social networks continue to grow, usage of mobile devices to publish and share personal information on social networking platforms has become more commonplace.

As an example, when a user uses an application, e.g., views a video or plays a game, on a mobile device such as a mobile phone or a mobile terminal and wants to share an image with friends, the user can share the image through a an instant messaging platform such as QQ, Weibo, or WeChat. Typically, in such a case, the user taps the screen of the mobile device, taps the pause button, taps the menu button, and then taps a share button to obtain a screenshot of a current image. After confirming that the screenshot content is correct, the user taps the send button to complete the sharing. In addition, after the entire sharing process is completed, the user manually continues running the application. The overall operating process is cumbersome, inconveniences users, and detracts from the user's experience.

### BRIEF DESCRIPTION OF THE DRAWINGS

Various embodiments of the invention are disclosed in the following detailed description and the accompanying drawings.

FIG. 1 presents a flowchart illustrating an embodiment of a method for sharing data.

FIGS. 2A and 2B present flowcharts illustrating another embodiment of a method for sharing data.

FIG. 3 presents a flowchart illustrating an embodiment of a method for sharing screenshot data through a social networking platform.

FIG. 4 presents a flowchart illustrating an embodiment of a method for sharing screenshot data through an instant messaging platform.

FIG. 5 presents a flowchart illustrating an embodiment of a method for sharing screenshot data through a short message service platform or an email platform.

FIG. 6 presents a flowchart illustrating another embodiment of a method for sharing data.

FIG. 7 presents a flowchart illustrating another embodiment of a method for sharing data.

FIG. 8 presents a structural block chart illustrating an embodiment of a device for sharing data.

FIG. 9 presents a structural block chart illustrating another embodiment of a device for sharing data.

FIG. 10 presents a structural block chart illustrating an embodiment of a system for sharing data.

FIG. 11 presents a functional diagram illustrating an embodiment of a programmed computer system for sharing data.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The present application discloses that application developers are provided with a development component for implementing application data sharing functions (or as follows: application developers are provided with a processing interface for sharing application data). As a result, a user can share application data by shaking a mobile device while using a mobile device to execute any application developed by an application developer.

In addition, the present application further discloses that the application data shared by each user in specific time segments are analyzed to identify currently popular applications, and the analysis results are presented to the application developer to more precisely develop and promote applications and thus increase application usage and earnings.

In this document, “application” refers to application software or an application program for mobile devices. Examples of applications include game applications, text applications, video playing applications, etc. An “application developer” refers to a person or group of people that develops application software or application programs. Application content can involve various aspects including, for example, screen images, pictures, text, music, video, etc.

In some embodiments, a thread is created on the device to send a hypertext transfer protocol (HTTP) request to a server, and the server posts the request to a platform (e.g., a social networking platform, an instant messaging platform, a short message service (SMS) platform, an email platform, etc.).

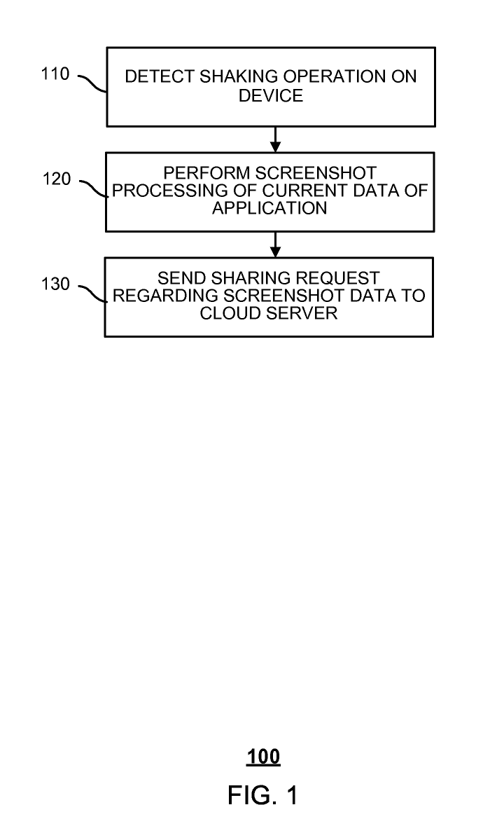

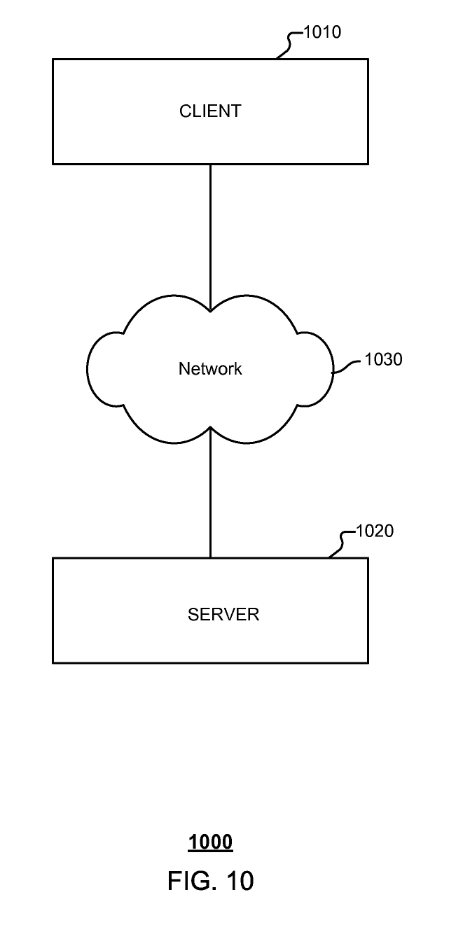

FIG. 1 presents a flowchart illustrating an embodiment of a method for sharing data. In some embodiments, the method 100 is performed by a device 1010 of FIG. 10 and comprises:

In 110, the device detects a shaking operation on a device of a user.

In some embodiments, while a user is executing an application on the user's device such as a mobile phone, a tablet, or another user's mobile device, an accelerometer built into the user's device is invoked to detect whether the user has performed a shaking operation on the user's device. For example, the device determines whether the user is shaking the device at an acceleration that exceeds a preset threshold value to determine whether a shaking operation performed by the user on the device has been detected. In the event that the acceleration exceeds a preset threshold value, the device determines that a shaking operation has been detected. In the event that the acceleration does not exceed a preset threshold value, the device determines that a shaking operation has not been detected.

In 120, in the event that a shaking operation is detected, the device performs screenshot processing of current data of an application to obtain screenshot data.

For example, when a shaking operation is detected, i.e., when a shaking event is triggered, screenshot processing is automatically performed on an application's current data, such as current screen images, pictures, and other content, to obtain the screenshot data.

In some embodiments, the screenshot processing can be performed based on any suitable method. In some embodiments, when the application does not involve special views as in a game or a display video, the device can simply cache images from the current page of the application and then directly obtain the screenshot data. In some embodiments, when the application involves special views, as in games or display videos, screenshot data is obtained by capturing the game or video image data using a screenshot adapter. As an example, the screenshot adapter corresponds to an implementation of taking a screenshot.

In some embodiments, the current data during a shaking operation undergoes screenshot processing while the application is executing. The current data corresponds to the current screen at the time of the shaking operation. In some embodiments, the application is paused in response to a detection of a shaking operation.

In 130, the device sends a sharing request regarding the screenshot data to a server to share the screenshot data. In some embodiments, the server corresponds to a cloud server.

For example, after the screenshot data is obtained, the device automatically sends a sharing request to the server to request sharing of the screenshot data. In some embodiments, the sharing request includes screenshot data information and sharing method information.

The sharing method can be chosen by the user, or the sharing method can be preset by the application or by the user.

In some embodiments, the device sends the sharing request regarding the screenshot data to the server to share the screenshot data through a social networking platform, an instant messaging platform, a short message service (SMS) platform, an email platform, or any combination thereof. In some embodiments, the server includes a single server having a communication function such as social networking, instant messaging, SMS, email, or any combination thereof, or the server includes multiple independent servers each of which has one or more of the communication functions.

In some embodiments, after the screenshot processing is performed and before the sharing request regarding the screenshot data is sent to the server, the screenshot data is displayed, and the user is requested to confirm the screenshot data and the platform where the screenshot data is to be published. For example, the platform corresponds to a social networking platform, such as, e.g., Twitter, Facebook, Linkedin, etc. Furthermore, the device sends the sharing request to the server after the user confirmation is received. In some embodiments, the device directly send the sharing request that shares the screenshot data obtained from the screenshot processing to the server without user confirmation.

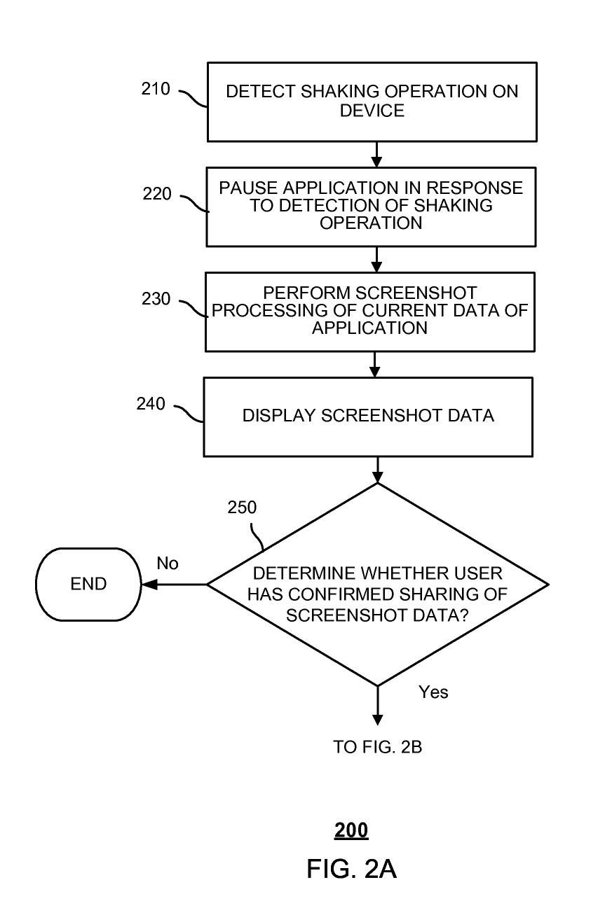

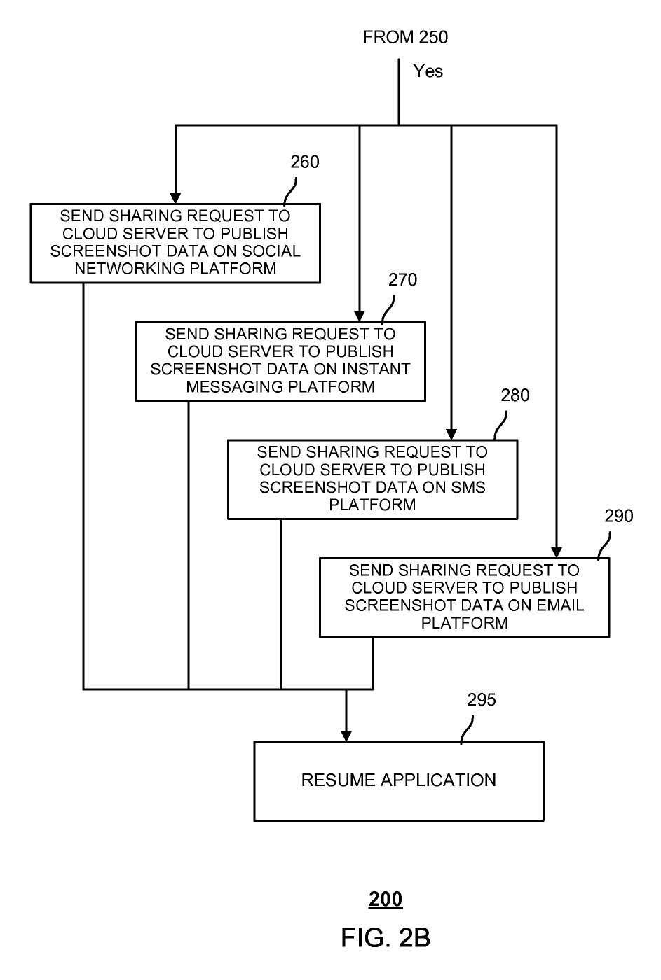

The method for sharing data is to be further described in light of FIGS. 2-5.

FIGS. 2A and 2B present flowcharts illustrating another embodiment of a method for sharing data. In some embodiments, the method 200 is performed by a device 1010 of FIG. 10 and comprises:

In 210, the device detects a shaking operation on a device of a user. The shaking operation processing 210 corresponds to operation 110 of FIG. 1 and will not be further discussed for conciseness.

In 220, when a shaking operation is detected, the device pauses an application in response to the detection of the shaking operation.

In 230, after the application is paused, the device performs screenshot processing of current data of the application to obtain screenshot data. The screenshot processing operation 230 corresponds to operation 120 of FIG. 1 and will not be further discussed for conciseness.

Please note that, although the application is first paused in operation 220 and then screenshot processing is performed in operation 230, the order in which operations 220 and 230 are performed can be reversed. In some embodiments, the pausing of the application is performed before the screenshot processing of the application's current data is performed. In some embodiments, the pausing of the application is performed while the screenshot processing is performed.

Through the pausing of the application in response to the detection of the shaking operation, user convenience can be increased without affecting the user's subsequent use of the application.

In 240, after the screenshot processing is completed, the device displays the screenshot data.

In 250, the device determines whether the user has confirmed sharing of the screenshot data. In other words, the user is requested to confirm whether the screenshot data obtained from screenshot processing is correct and/or complies with the needs of the user.

In some embodiments, the user is requested to confirm whether the screenshot data is correct. In some embodiments, the user is requested to confirm the sharing method for sharing the screenshot data. In some embodiments, the sharing method includes communication or contact methods including: a social networking platform, an instant messaging platform, an SMS platform, an email platform, or any combination thereof.

In this document, a “social networking platform” refers to a social networking website, such as Facebook, Weibo, Renren, or Kaixin001, that provides social networking services for each user to connect and communicate with other users. Users can publish screenshot data through these social networking websites and thus share the screenshot data with other website users on the social networking websites. In some embodiments, users can choose to publish the screenshot data using these social networking websites to be viewed only by specific users designated as the users' friends.

In this document, “instant messaging platforms” refer to instant messaging tools, such as QQ, MSN, WeChat, Easy Chat, and Laiwang, that can implement instant messaging services. Users can share the screenshot data with designated contacts through the instant messaging platforms.

In this document, “SMS platforms” refer to service platforms that can send and receive short messages. These service platforms include communications network platforms, Internet application platforms, or a combination thereof. Users can use short messages such as SMS or MMS to share screenshot data with designated contacts via these SMS platforms.

In this document, “email platforms” refer to service platforms that can provide electronic mailing services. Users can send emails to share screenshot data with designated contacts through the email platforms.

For example, when the user does not confirm the sharing of the screenshot data, the lack of confirmation indicates that the screenshot data is incorrect or that the user does not wish to share the screenshot data. Thus, the processing flow ends. As an example, a lack of confirmation can be indicated by a user canceling the sharing of the screenshot operation.

In the event that the user confirms sharing of the screenshot data, the screenshot data can be shared based on a default method or a method chosen by the user. For example, in the event that the user chooses to use a social networking platform to share the screenshot data, the flow proceeds to operation 260.

In 260, the device sends a sharing request to a server to publish the screenshot data on a social networking platform.

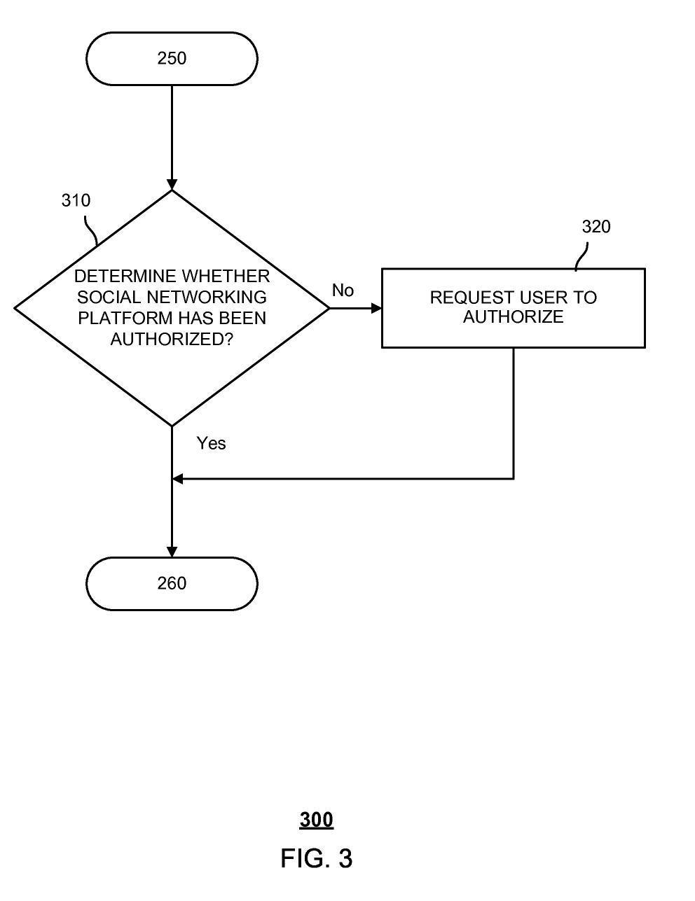

FIG. 3 presents a flowchart illustrating an embodiment of a method for sharing screenshot data through a social networking platform. In some embodiments, the method 300 is an optional process performed before operation 260 of FIG. 2B and comprises:

After the user confirms sharing of the screenshot data via a social networking platform (operation 250), the flow proceeds to operation 310.

In 310, the device determines whether the social networking platform has been authorized. In other words, a social networking platform being authorized corresponds with the user being logged into a social networking platform.

In 320, in the event that the social networking platform is determined as unauthorized, the device requests a user to authorize. For example, the user is requested to enter a username and password to log onto the unauthorized social networking platform. After the social networking platform is determined to be authorized, or after the user is authorized, the device sends a sharing request regarding the screenshot data to the server to publish the screenshot data on a preset social networking platform (operation 260). In other words, after receiving the user confirmation about sharing the screenshot data, the device sends the sharing request to the server to publish the screenshot data on the preset social networking platform.

Referring back to FIGS. 2A and 2B, in the event that the user confirms the sharing of the screenshot data, the user can choose to use an instant messaging platform to share the screenshot data. In this case, flow proceeds to operation 270.

In 270, the device sends the sharing request a server to share the screenshot data with designated contacts via an instant messaging platform.

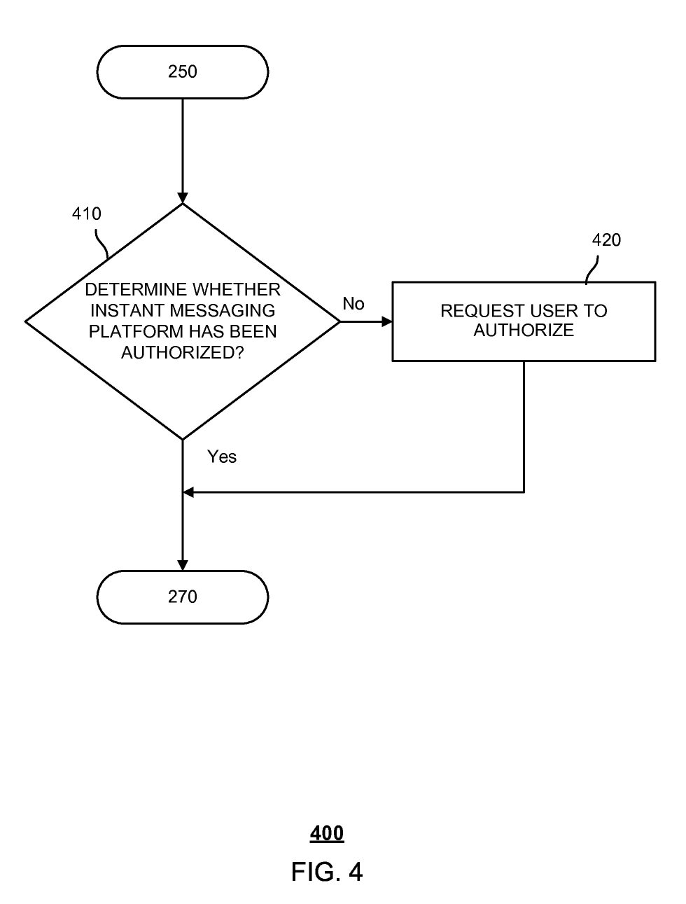

FIG. 4 presents a flowchart illustrating an embodiment of a method for sharing screenshot data through an instant messaging platform. In some embodiments, the method 400 is an optional process performed before operation 270 of FIG. 2B and comprises:

After the user confirms the sharing of the screenshot via an instant messaging platform (operation 250), the flow proceeds to operation 410.

In 410, the device determines whether the instant messaging platform has been authorized.

In 420, in the event that the instant messaging platform is determined as unauthorized, the device requests a user to authorize. For example, the user is requested to enter a username and password to log onto the unauthorized instant messaging platform.

After the instant messaging platform is determined to be authorized, or after user authorization is obtained, the user is requested to designate contacts. In other words, the user is requested to designate instant messaging contacts whereby the screenshot data is to be shared with the designated contacts. For example, when QQ is selected for sharing the screenshot data, the user is to designate a QQ group, specific friends, specific contacts, or any combination thereof that the user wishes to share the snapshot data with. The device sends a sharing request regarding the screenshot data to the server to share the screenshot data with the designated contacts through an instant messaging platform (operation 270).

Referring back to FIGS. 2A and 2B, in the event that the user confirms the sharing of the screenshot data, the user can choose to use an SMS platform to share the screenshot data.

In 280, the device sends a sharing request to a server to share the screenshot data with designated contacts through an SMS platform.

Similarly, when the user confirms the sharing of the screenshot data, the user can choose to use an email platform to share the screenshot data.

In 290, the device sends a sharing request to a server to share the screenshot data with designated contacts through an email platform.

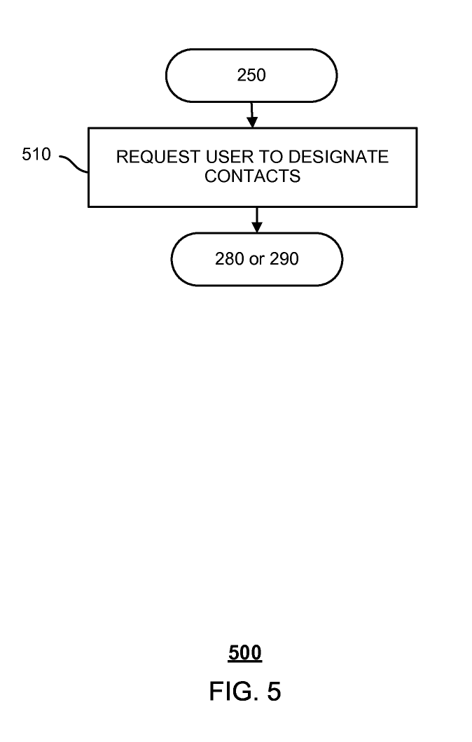

FIG. 5 presents a flowchart illustrating an embodiment of a method for sharing screenshot data through a short message service platform or an email platform. In some embodiments, the method 500 is an optional process performed before operation 280 or 290 of FIG. 2B and comprises:

In 510, after the user confirms the sharing of the screenshot data via an SMS platform or an email platform (operation 250), the device requests the user to designate contacts. In other words, the user is asked to designate, in a SMS contact list, an email contact list, or the like, specific contacts who will share the screenshot data.

The device sends a sharing request regarding the screenshot data to a server to share the screenshot data with the designated contacts through the SMS platform or the email platform (operation 280 or 290).

Referring back to FIGS. 2A and 2B, in 295, after the device sends the sharing request to a server, the device resumes the paused application to execute the application normally. Thus, the user can very conveniently continue to use the application with an enhanced user experience.

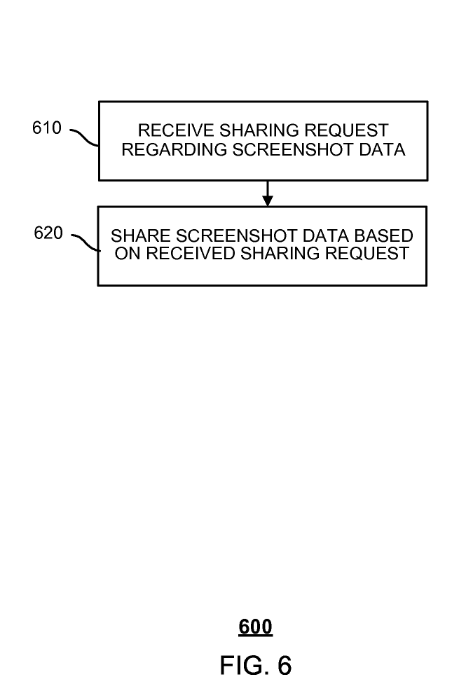

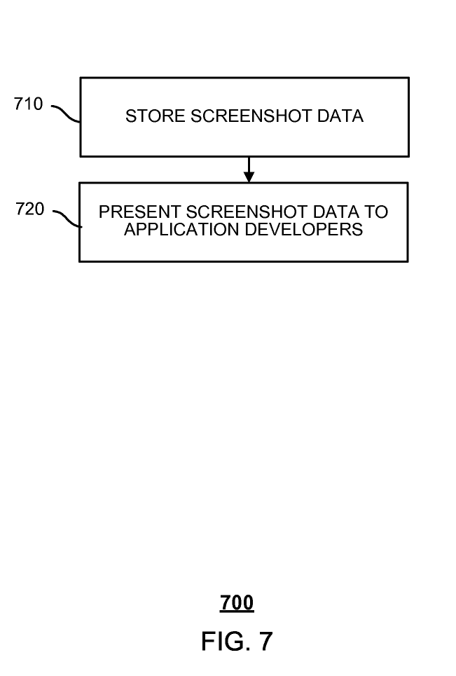

Embodiments of methods for sharing data that enables current application data to be shared by a simple shaking operation while the application is being executed are described in light of FIGS. 1-5. The above embodiments of the methods for sharing data are implemented by a client. For example, the client is a mobile terminal. Embodiments of methods for sharing data are described from the perspective of a server in light of FIGS. 6 and 7.

FIG. 6 presents a flowchart illustrating another embodiment of a method for sharing data. In some embodiments, the method 600 is implemented by a server 1020 of FIG. 10 and comprises:

In 610, the server receives a sharing request regarding screenshot data. The screenshot data is obtained from screenshot processing performed on current data of an application in response to detecting a user performing a shaking operation on a device of the user.

For example, a client application can, in response to the detection of a shaking operation performed by a user on a device of the user, obtain screenshot data by performing screenshot processing on current data of the application, and can send a sharing request regarding the screenshot data to a server. Accordingly, the server can receive the sharing request from a client.

In 620, the server shares the screenshot data based on the received sharing request.

For example, a server shares the screenshot data through a corresponding sharing method interface based on the screenshot data and sharing method included in the sharing request. In some embodiments, the sharing method interface corresponds to an application programming interface (API). In one example, when the sharing method relates to social networking platforms, the server publishes the screenshot data under the names of users on the various social networking platforms through the various interfaces corresponding to the social networking platforms and thus shares the screenshot data with the corresponding social networking platforms or with portions of friends on the social networking platforms. In some embodiments, a social networking platform interface corresponds to an application programming interface (API). When the sharing method corresponds to an instant messaging platform, the server can share the screenshot data with designated contacts through the instant messaging method based on an interface with a corresponding instant messaging platform. In some embodiments, an instant messaging platform interface corresponds to an application programming interface (API). When the sharing method is an SMS platform or an email platform, the server can share the screenshot data with designated contacts by sending short messages or emails through a corresponding SMS platform or email platform interface. In some embodiments, an email platform interface or a SMS platform interface corresponds to an application programming interface (API).

The server processing process of an embodiment of the method for sharing data has been described. A large volume of application content shared by a large volume of users can be received by the server, whereupon the application data shared by each user in specific time segments can be analyzed to identify applications that are currently popular. If the analysis results are presented to application developers, the application developers are to be able to develop and promote applications more precisely and thus increase usage volumes.

FIG. 7 presents a flowchart illustrating another embodiment of a method for sharing data. In some embodiments, the method 700 is implemented by a server 1020 of FIG. 10 and comprises:

In 710, the server stores screenshot data.

For example, the server stores screenshot data in “shake-and-share” requests (sharing requests) received in a specific time segment in a server database. In other words, after the server receives a sharing request, the server first determines whether the sharing request corresponds to a sharing request issued from a user by shaking the user's device. In the event that the sharing request corresponds to a sharing request issued from a user by shaking the user's device, the screenshot data in the sharing request is stored in a server database for subsequent analysis.

In 720, the server presents the screenshot data to application developers.

For example, the server can, for each specific time segment, obtain the “shake-and-share” screenshot data that was received in a specific time segment from the server database and present the “shake-and-share” screenshot data to the application developers.

The screenshot data can be presented to the application developers through any suitable method. For example, the screenshot data is exhibited to the application developers through a Web-based photo wall. In another example, the application developers can receive the screenshot data through the server via open APIs, and then the application developers can use the screenshot data however they want. Thus, the application developers are to be able to develop and promote applications more precisely and thus increase usage volumes.

The embodiments of the methods for sharing data were described above in light of FIGS. 1-7. Similarly, devices for sharing data corresponding to the above methods are to be described.

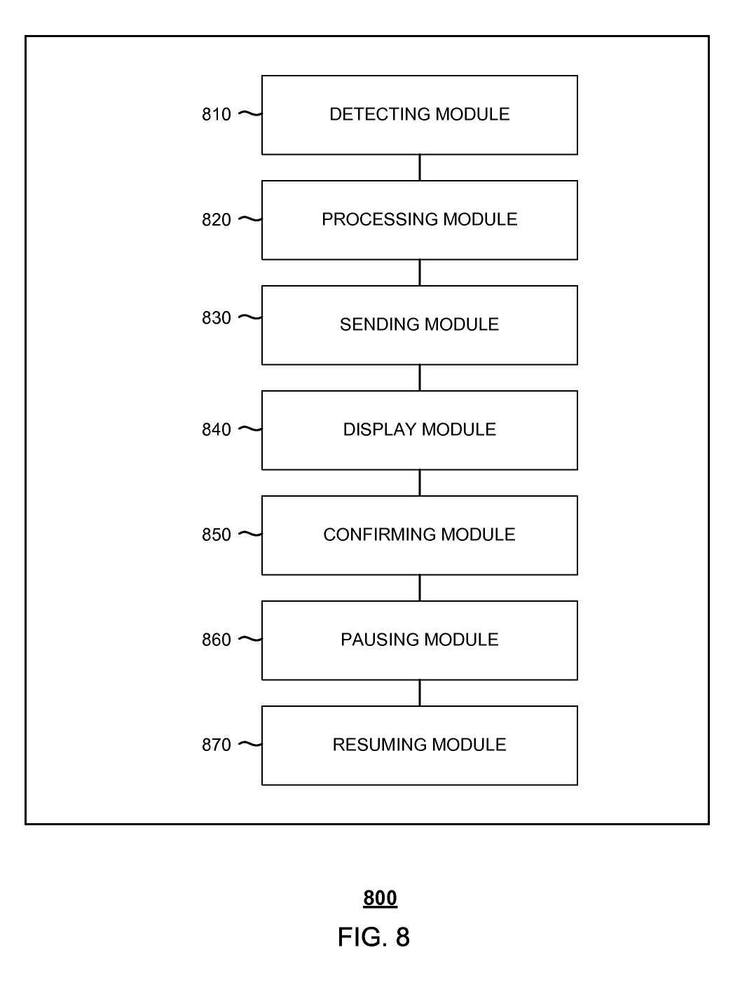

FIG. 8 presents a structural block chart illustrating an embodiment of a device for sharing data. In some embodiments, the device 800 is configured to implement method 100 of FIG. 1 and comprises a detecting module 810, a processing module 820, and a sending module 830.

In some embodiments, the detecting module 810 detects a user performing a shaking operation on a device of the user.

In some embodiments, the processing module 820 performs screenshot processing of current data of an application in response to detecting a shaking operation to obtain screenshot data.

In some embodiments, the sending module 830 sends a sharing request regarding the screenshot data to a server to share the screenshot data.

In some embodiments, the device 800 further comprises a display module 840 and a confirming module 850.

In some embodiments, the display module 840 displays the screenshot data.

In some embodiments, the confirming module 850 receives a user confirmation operation for sharing of the screenshot data.

In some embodiments, the device 800 further comprises a pausing module 860.

In some embodiments, the pausing module 860 pauses the application in response to the detecting of the shaking operation by the detecting module 810.

In some embodiments, the device 800 further comprises a resuming module 870.

In some embodiments, the resuming module 870 resumes the paused application in response to the sending of the sharing request by the sending module 830.

In some embodiments, the sending module 830 sends the sharing request regarding the screenshot data to the server to share the screenshot data through: publishing the screenshot data on a social networking platform, sharing the screenshot data with designated contacts through an instant messaging platform, sharing the screenshot data with designated contacts through an SMS platform, sharing the screenshot data with designated contacts through an email platform, or any combination thereof.

The modules described above can be implemented as software components executing on one or more general purpose processors, as hardware such as programmable logic devices and/or Application Specific Integrated Circuits designed to perform certain functions or a combination thereof. In some embodiments, the modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules may be implemented on a single device or distributed across multiple devices. The functions of the modules may be merged into one another or further split into multiple sub-modules.

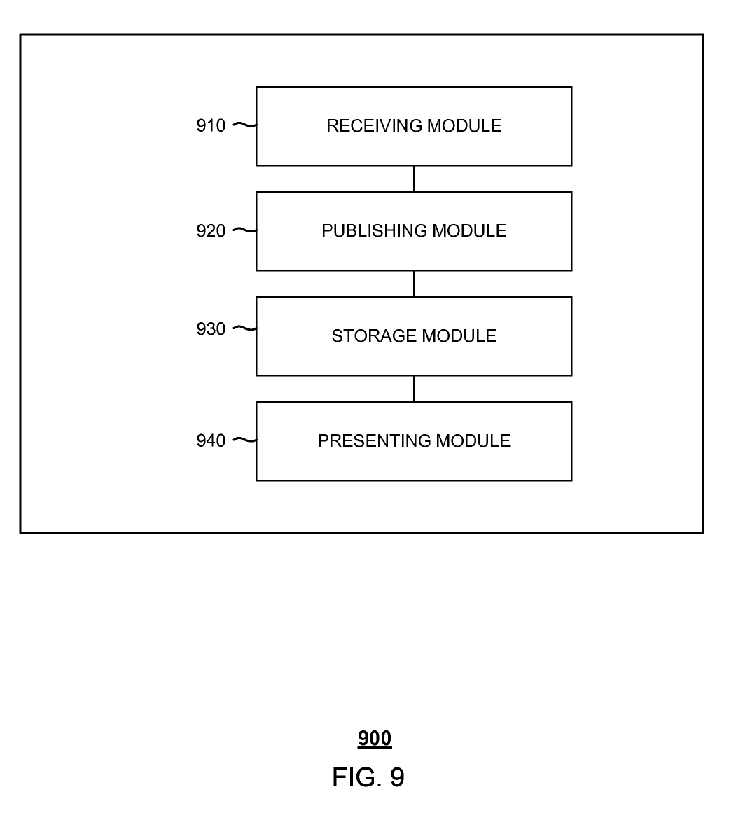

FIG. 9 presents a structural block chart illustrating another embodiment of a device for sharing data. In some embodiments, the device 900 is configured to implement method 700 of FIG. 7 and comprises a receiving module 910 and a publishing module 920.

In some embodiments, the receiving module 910 receives a sharing request regarding screenshot data. The screenshot data is obtained from screenshot processing performed on the current data of an application in response to detecting a user perform a shaking operation on a device of the user.

In some embodiments, the sharing module 920 shares the screenshot data based on the sharing request.

In some embodiments, the sharing module 920 shares the screenshot data based on a sharing request through: publishing the screenshot data on a social networking platform, sharing the screenshot data with designated contacts through an instant messaging platform, sharing the screenshot data with designated contacts through an SMS platform, sharing the screenshot data with designated contacts through an email platform, or any combination thereof.

In some embodiments, the device 900 further comprises a storage module 930 and a presenting module 940.

In some embodiments, the storage module 930 stores screenshot data.

In some embodiments, the presenting module 940 presents the stored screenshot data to application developers. In some embodiments, the screenshot data is presented in a photo wall to application developers.

FIG. 10 presents a structural block chart illustrating an embodiment of a system for sharing data. In some embodiments, the system 1000 includes a client or client device 1010 connected to a server or a cloud server 1020 via a network 1030.

In some embodiments, the client device 1010 detects a user shaking the client device 1010. In response to the detecting of the shaking of the client device, the client device performs screenshot processing of current data of an application to obtain screenshot data, and sends a sharing request regarding to the screenshot data to the server 1020 to share the screenshot data.

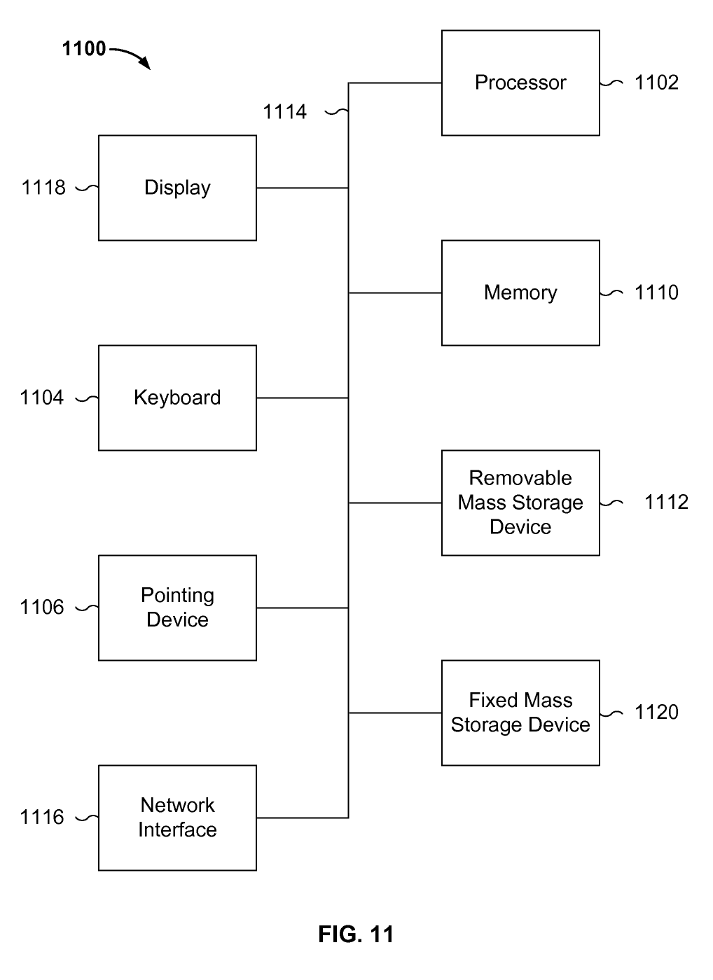

FIG. 11 presents a functional diagram illustrating an embodiment of a programmed computer system for sharing data. As will be apparent, other computer system architectures and configurations can be used to share data. Computer system 1100, which includes various subsystems as described below, includes at least one microprocessor subsystem (also referred to as a processor or a central processing unit (CPU)) 1102. For example, processor 1102 can be implemented by a single-chip processor or by multiple processors. In some embodiments, processor 1102 is a general purpose digital processor that controls the operation of the computer system 1100. Using instructions retrieved from memory 1110, the processor 1102 controls the reception and manipulation of input data, and the output and display of data on output devices (e.g., display 1118).

Processor 1102 is coupled bi-directionally with memory 1110, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 1102. Also as is well known in the art, primary storage typically includes basic operating instructions, program code, data and objects used by the processor 1102 to perform its functions (e.g., programmed instructions). For example, memory 1110 can include any suitable computer-readable storage media, described below, depending on whether, for example, data access needs to be bi-directional or uni-directional. For example, processor 1102 can also directly and very rapidly retrieve and store frequently needed data in a cache memory (not shown).

A removable mass storage device 1112 provides additional data storage capacity for the computer system 1100, and is coupled either bi-directionally (read/write) or uni-directionally (read only) to processor 1102. For example, storage 1112 can also include computer-readable media such as magnetic tape, flash memory, PC-CARDS, portable mass storage devices, holographic storage devices, and other storage devices. A fixed mass storage 1120 can also, for example, provide additional data storage capacity. The most common example of mass storage 1120 is a hard disk drive. Mass storage 1112, 1120 generally store additional programming instructions, data, and the like that typically are not in active use by the processor 1102. It will be appreciated that the information retained within mass storage 1112 and 1120 can be incorporated, if needed, in standard fashion as part of memory 1110 (e.g., RAM) as virtual memory.

In addition to providing processor 1102 access to storage subsystems, bus 1114 can also be used to provide access to other subsystems and devices. As shown, these can include a display monitor 1118, a network interface 1116, a keyboard 1104, and a pointing device 1106, as well as an auxiliary input/output device interface, a sound card, speakers, and other subsystems as needed. For example, the pointing device 1106 can be a mouse, stylus, track ball, or tablet, and is useful for interacting with a graphical user interface.

The network interface 1116 allows processor 1102 to be coupled to another computer, computer network, or telecommunications network using a network connection as shown. For example, through the network interface 1116, the processor 1102 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 1102 can be used to connect the computer system 1100 to an external network and transfer data according to standard protocols. For example, various process embodiments disclosed herein can be executed on processor 1102, or can be performed across a network such as the Internet, intranet networks, or local area networks, in conjunction with a remote processor that shares a portion of the processing. Additional mass storage devices (not shown) can also be connected to processor 1102 through network interface 1116.

An auxiliary I/O device interface (not shown) can be used in conjunction with computer system 1100. The auxiliary I/O device interface can include general and customized interfaces that allow the processor 1102 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 11 is but an example of a computer system suitable for use with the various embodiments disclosed herein. Other computer systems suitable for such use can include additional or fewer subsystems. In addition, bus 1114 is illustrative of any interconnection scheme serving to link the subsystems. Other computer architectures having different configurations of subsystems can also be utilized.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for sharing data, comprising:
detecting a shaking operation performed on a device by a user;
in response to the detecting of the shaking operation, performing screenshot processing of current data of an application to obtain screenshot data; and
sending a sharing request regarding the screenshot data to a server to share the screenshot data.

2. The method as described in claim 1, further comprising:
after the performing of the screenshot processing of the current data of the application and before the sending of the sharing request to the server:
displaying the screenshot data; and
receiving a user confirmation operation to share the screenshot data.

3. The method as described in claim 1, further comprising:
pausing the application in response to the detecting of the shaking operation.

4. The method as described in claim 3, further comprising:
resuming the application in response to the sending of the sharing request.

5. The method as described in claim 1, wherein the sending of the sharing request regarding the screenshot data to the server comprises:
publishing the screenshot data on a social networking platform;
sharing the screenshot data with designated contacts through an instant messaging platform;
sharing the screenshot data with designated contacts through a short message service (SMS) platform;
sharing the screenshot data with designated contacts through an email platform; or
any combination thereof.

6. A method comprising:
receiving a sharing request regarding screenshot data, the screenshot data being obtained from screenshot processing performed on current data of an application in response to detecting a user performing a shaking operation on a device of the user while the application is being executed; and
sharing the screenshot data based on the sharing request.

7. The method as described in claim 6, wherein the sharing of the screenshot data based on the sharing request comprises:
publishing the screenshot data on a social networking platform;
sharing the screenshot data with designated contacts through an instant messaging platform;
sharing the screenshot data with designated contacts through a short message service (SMS) platform;
sharing the screenshot data with designated contacts through an email platform; or
any combination thereof.

8. The method as described in claim 6, further comprising:
storing the screenshot data; and
presenting the screenshot data to application developers.

9. The method as described in claim 8, wherein the presenting of the screenshot data to the application developers comprises:
presenting the screenshot data in the form of a photo wall to the application developers.

10. A device for sharing data, comprising:
a detecting module configured to detect a shaking operation performed by a user;
a processing module configured to perform screenshot processing of current data of an application in response to the detecting of the shaking operation to obtain screenshot data; and
a sending module configured to send a sharing request regarding the screenshot data to a server to share the screenshot data.

11. The device as described in claim 10, further comprising:
a display module configured to display the screenshot data; and
a confirming module configured to receive a user confirmation operation to share the screenshot data.

12. The device as described in claim 10, further comprising:
a pausing module configured to pause the application in response to the detecting of the shaking operation.

13. The device as described in claim 12, further comprising:
a resuming module configured to resume the application in response to the sending of the sharing request.

14. The device as described in claim 10, wherein the sending module is further configured to:
publish the screenshot data on a social networking platform;
share the screenshot data with designated contacts through an instant messaging platform;
share the screenshot data with designated contacts through a short message service (SMS) platform;
sharing the screenshot data with designated contacts through an email platform; or
any combination thereof.

15. A device for sharing data, comprising:
a receiving module configured to receive a sharing request regarding screenshot data, the screenshot data being obtained from screenshot processing performed on the current data of an application in response to detecting a shaking operation performed by a user; and
a sharing module configured to share the screenshot data based on the sharing request.

16. The device as described in claim 15, wherein the sharing module is further configured to:
publish the screenshot data on a social networking platform;
share the screenshot data with designated contacts through an instant messaging platform;
share the screenshot data with designated contacts through a short message service (SMS) platform;
share the screenshot data with designated contacts through an email platform; or
any combination thereof.

17. The device as described in claim 15, further comprising:
a storage module configured to store the screenshot data; and
a presenting module configured to present the screenshot data to application developers.

18. The device as described in claim 17, wherein the presenting module is further configured to present the screenshot data in the form of a photo wall to the application developers.

19. A computer program product for sharing data, the computer program product being embodied in a tangible non-transitory computer readable storage medium and comprising computer instructions for:
detecting a shaking operation performed on a device by a user;
in response to the detecting of the shaking operation, performing screenshot processing of current data of an application to obtain screenshot data; and
sending a sharing request regarding the screenshot data to a server to share the screenshot data.

20. A computer program product for sharing data, the computer program product being embodied in a tangible non-transitory computer readable storage medium and comprising computer instructions for:
receiving a sharing request regarding screenshot data, the screenshot data being obtained from screenshot processing performed on the current data of an application in response to detecting a shaking operation performed on a device by a user while the application is being is executed; and
sharing the screenshot data based on the sharing request.
